(19) United States
(12) Patent Application Publication
(10) Pub. No.: US 2002/0165098 A1
(43) Pub. Date: Nov. 7, 2002

(54) Dip coating of YBCO films on three dimensional substrates

(76) Inventor: David S. Applegate, Wheeling, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/799,781

(22) Filed: Mar. 6, 2001

(51) Int. Cl. C11D 1/00

(52) U.S. Cl. 505/100

(57) ABSTRACT

A method for providing a superconductive coating on three dimensional substrates by dip coating is disclosed. The dip coating formulation includes terpineol, butoxyethyl acetate, binder, dispersant, YBCO, and alcohol and has a viscosity ranging from 60 cPs to about 125 cPs. After the substrate is dipped in the dip coating formulation, it is dried, baked and then sintered. The formulation is prepared by dissolving the binder and the dispersant in the terpineol and butoxyethyl acetate solvents to create a vehicle. The YBCO is then milled with a vehicle to create a thick ink which is subsequently thinned with ethanol to produce a dip ink formulation having the aforenoted viscosity.

### FIELD OF THE INVENTION

The present invention relates generally to superconducting materials, and more particularly to methods of manufacturing structures, including three dimensional structures, coated with high-temperature superconducting materials and manufacturing high-temperature superconducting coatings.

### BACKGROUND OF THE DISCLOSURE

The discovery that certain ceramic materials exhibit superconductivity at above liquid nitrogen temperatures has stimulated intensive research. One such ceramic material is YBa₂Cu₃O₆₊ₓ where x ranges from 0 to 1 or YBCO. Many uses for such materials have been suggested and attempted, including, for example, devices operating with microwave or radio frequency signals such as antennas, magnetic resonance imaging pickup coils, resonators, and the like. Optimal performance of such devices may depend upon having the lowest possible surface resistance.

Low-surface resistance high-temperature superconducting materials have been successfully fabricated in the form of thin films of ceramic. Such films typically have a thickness on the order of 0.5 μm and are formed by depositing the ceramic material or its precursors on the surface of a planar, single crystal substrates using techniques such as co-evaporation, sputtering, laser ablation, and molecular beam epitaxy. The disadvantages of these techniques are discussed in U.S. Pat. Nos. 5,789,347 and 6,119,025 which disclose a “melt texture” process.

The melt texture process of the '347 and '025 patents involves heating a film on a zirconia ceramic substrate at a temperature above 1015° C. in pure oxygen. The heat treatment is fast and relatively simple, but it cannot be used on metallic substrates due to the extreme temperatures (>1015° C.) utilized. The typical surface resistance of the flat films produced by the melt texture process of the '347 and '025 patents are about 0.1 milliohms while the surface resistance of small diameter curved surfaces, e.g., 1-3 mm diameter, is somewhat higher, about 0.3 milliohms at 2 GHz and 77° K.

U.S. Pat. Nos. 5,340,797 and 5,527,765 disclose a “reactive texture” process which involves forming films on metallic substrates which are then heated to near 900° C. Substrates are typically stainless steel or INCONEL™ (a.k.a. PYROMET™) which require thick silver plating before the application of the YBCO film. The heat treatment requires multiple gas changes including a warm-up in carbon dioxide. The dwell is typically performed in a 2 Torr oxygen atmosphere, but it is claimed to work in higher oxygen concentrations all the way up to pure oxygen. The process is very sensitive and can be difficult to control.

U.S. Pat. No. 5,856,277 discloses a process which is a way to alter the surface of a bulk pellet of YBCO. In this so-called “surface texture process,” the top layer of the resulting structure is typically much thicker than the film produced in the melt texture and reactive texture processes discussed above.

The melt texture, surface texture, and reactive texture processes all utilize some degree of melting and recrystallization. The YBCO grain size in the surface texture process of the '277 patent is typically somewhat smaller than that of the melt texture and reactive texture processes, but the surface resistance is about the same as in the other two texturing methods.

Conventional sinter processes use the same substrates and temperatures as the reactive texture process of the '797 and '765 patents but such a conventional sinter process uses only phase-pure YBCO and do not involve melting any portion of the film. There is a single gas change at the end of the dwell time at maximum temperature when oxygen concentration is switched from a 1% oxygen atmosphere to a pure oxygen atmosphere. Conventional sinter processes are typically easy to perform but result in films with a surface resistance that is significantly higher than that obtained by the melt texture, reactive texture, and surface texture processes. However, the surface resistance provided by the conventional sinter processes is superior to that of ordinary conductors such as copper or silver, even at 77° K. Unlike the melt texture, reactive texture, and surface texture processes, the YBCO grains produced by the conventional sintering processes are microscopic and randomly oriented, thus resulting in higher surface resistance.

The '347, '025, '797, '765 and '277 patents are all owned by the assignee of the present application and the disclosures of said patents are incorporated herein by reference.

Currently available coating processes are difficult to control and/or time consuming to carry out and, as a result, substantially add to the cost of manufacturing the finished product.

Therefore, there is a need for a coating process which enables a superconductive coating with a satisfactory resistance to be applied to a complex three dimensional substrate in an efficient manner which can lower the cost of the finished product.

### SUMMARY OF THE DISCLOSURE

The present invention satisfies the aforenoted need by providing a formulation for dip coating a superconducting coating on a substrate. One disclosed formulation comprises terpineol, butoxyethyl acetate, one or more binders, one or more dispersants, YBa₂Cu₃O₆₊ₓ and an alcohol. It is anticipated that the formulation of the present invention will be applicable to superconductors other than YBCO and other powders used for coating substrates and other objects.

In a further refinement, the present invention provides a formulation for dip coating a superconducting coating on a three dimensional substrate that comprises a formulation for dip coating a superconducting coating onto a substrate, the formulation comprising: from about 6 to about 8 wt % terpineol, from about 6 to about 8 wt % butoxyethyl acetate, from about 0.4 to about 1.0 wt % binder, from about 0.5 to about 2 wt % of a dispersant, from about 60 to about 70 wt % YBa₂Cu₃O₆₊ₓ, and from about 18 to about 20 wt % alcohol.

In another refinement, the present invention provides a method for applying a superconducting coating onto a substrate providing a dip coating formulation that comprises terpineol, butoxyethyl acetate, one or more binders, one or more dispersants, YBa₂Cu₃O₆₊ₓ and an alcohol, dipping the substrate in the dip coating formulation, removing the substrate from the dip coating formulation and drying the substrate, baking the substrate and sintering the substrate.

In still a further refinement, the present invention provides a method for preparing a formulation for dip coating a superconducting coating onto a substrate. The method comprises providing at least two solvents comprising terpineol and butoxyethyl acetate, dissolving the binders and dispersants in the solvents to form a vehicle, milling YBa₂Cu₃O₆₊ₓ powder and the vehicle to produce an ink, and thinning the ink with an alcohol to a viscosity ranging from about 60 cPs to about 125 cPs.

### DETAILED DESCRIPTION OF THE PRESENTLY PREFERRED EMBODIMENTS

The formulation for dip coating complex three dimensional substrates and other substrates includes terpineol in an amount ranging from about 6 wt % to about 8 wt %, butoxyethyl acetate in an amount ranging from about 6 wt % to about 8 wt % and alcohol, preferably ethanol, in an amount ranging from about 18 wt % to about 20 wt %. The terpineol, butoxyethyl acetate and ethanol serve as solvents. The terpineol is preferably alpha-terpineol and alcohol is preferably ethanol and more preferably anhydrous ethanol. The formulation also includes binders such as acryloid in amount ranging from about 0.2 wt % to about 0.5 wt % and ethylcellulose in an amount ranging from about 0.2 wt % to about 0.5 wt %. The acryloid is preferably B-67 acryloid and the ethylcellulose is preferably T-200 ethylcellulose. At least one dispersant is also employed in an amount ranging from about 0.5 wt % to about 2 wt %. The dispersant is preferably Emcol, more preferably Emcol CC-42. The superconductive material is preferably YBa₂Cu₃O₆₊ₓ or YBCO, also known as 123. However, other superconducting materials other than YBCO and other powdered materials used in coatings may be substituted fro the YBCO. The YBCO is preferably provided in an amount ranging from about 60 wt % to about 70 wt %.

One preferred formulation is as follows:

| Ink Component Name | Preferred Weight % |
|---|---|
| Alpha-terpineol | 7.0 |
| Butoxyethyl acetate (a.k.a. “BCA”) | 7.0 |
| B-67 acryloid (a.k.a. “paraloid”) | 0.37 |
| T-200 ethylcellulose | 0.37 |
| Emcol CC-42 | 1.17 |
| YBa₂Cu₃O₆₊ₓ (a.k.a. “YBCO” or “123”) | 65.15 |
| Anhydrous ethanol (a.k.a. ethyl alcohol) | 18.94 |

Generally, the solvent content controls the viscosity. Accordingly, when alpha-terpineol, butoxyethyl acetate and ethanol are chosen as the solvents, if too much alpha-terpineol is provided, the ink formulation can be too thin, resulting in a film that is too thin. If an insufficient amount of alpha-terpineol is provided, the ink formulation can be too viscous resulting in a film that is too thick. Similarly, if too much butoxyethyl acetate is provided, the ink formulation can be too thin, resulting in a film that is too thin. If an insufficient amount of butoxyethyl acetate is provided, the ink formulation can be too viscous resulting in a film that is too thick. Finally, if too much alcohol is provided, the ink formulation can be too thin, resulting in a film that is too thin. If an insufficient amount of alcohol is provided, the ink formulation can be too viscous resulting in a film that is too thick.

If the binder or binders are present in too great of an amount, the resulting ink formulation is too viscous and the resulting film can be too thin. If the binder or binders are present in an insufficient amount, the unfired film is too weak resulting in poor adhesion to the substrate.

Accordingly, when ethylcellulose is chosen as the binder, if the ethylcellulose is present in too great of an amount, the resulting ink formulation is too viscous and the resulting film can be too thin. If the ethylcellulose is present in an insufficient amount, the unfired film is too weak resulting in poor adhesion to the substrate.

If the dispersant, preferably Emcol CC-42, is present in too great of an amount, clumping may result and solids may settle out of the ink formulation. If the dispersant is provided in an insufficient amount, the YBCO powder may settle too quickly resulting in a poor suspension and, therefore, inferior coating.

If the YBCO is present in too great of an amount, the resultant ink formulation can be too viscous and the unfired film can be too weak. If the YBCO is present in an insufficient amount, the ink can be too thin or have an insufficient viscosity resulting in a fired film that is too thin.

Combinations of other solvents in addition to alpha-terpineol, butoxyethyl acetate and anhydrous ethanol may also be utilized. Binders other than B-67 acryloid and T-200 ethylcellulose may also be utilized. Dispersants other than Emcol CC-42 may also prove satisfactory.

In creating the dip ink formulation, the solids, i.e., the B-67 acryloid, T-200 ethylcellulose and Emcol CC-42, are dissolved in the alpha-terpineol and butoxyethyl acetate. Then, the YBCO is milled with the resulting vehicle to produce a thick ink. The thick ink is then thinned with the anhydrous ethanol to produce a low-viscosity slurry used as the dip ink formulation. A substrate, such as a stainless steel substrate, is then dipped into the dip ink formulation, removed and dried. During the drying process, the substrate can be rotated. Further, the drying process can be carried out a temperature of about 90° C. During the drying process, the substrate can be rotated at about 300 rpm. After drying, the substrate is baked at a temperature of about 80° C. for a time period of about 20 minutes. Finally, the substrate is sintered where the substrate is heated to a sintering temperature which preferably ranges from about 870° C. to about 890° C. and is held there from about 1 to about 3 hours. The heating and holding steps are preferably carried out in a 1% oxygen atmosphere. The cool down process is preferably carried out in a pure oxygen atmosphere. A preferred viscosity for the dip ink formulation is about 100 cPs but the viscosity can range from about 60 to about 125 cPS.

The foregoing detailed description has been given for clearness of understanding only, and no unnecessary limitations should be understood therefrom, as modifications would be obvious to those skilled in the art.

What is claimed:

1. A formulation for dip coating a superconducting coating onto a substrate, the formulation comprising:
from about 6 to about 8 wt % terpineol,
from about 6 to about 8 wt % butoxyethyl acetate,
from about 0.4 to about 1.0 wt % of a binder,
from about 0.5 to about 2 wt % of a dispersant,
from about 60 to about 70 wt % YBa₂Cu₃O₆₊ₓ, and
from about 18 to about 20 wt % of an alcohol.

2. The dip coating formulation of claim 1 wherein the terpineol is further characterized as being alpha terpineol.

3. The dip coating of claim 1 wherein the binder comprises acryloid and ethylcellulose.

4. The dip coating formulation of claim 3 wherein the acryloid is further characterized as being B-67 acryloid and is present in an amount ranging from about 0.2 wt % to about 0.5 wt %.

5. The dip coating formulation of claim 3 wherein the ethylcellulose is further characterized as being T-200 ethylcellulose and is present in an amount ranging from about 0.2 wt % to about 0.5 wt %.

6. The dip coating formulation of claim 1 wherein the dispersant is Emcol.

7. The dip coating formulation of claim 6 wherein the Emcol is further characterized as being Emcol CC-42.

8. The dip coating formulation of claim 1 wherein the alcohol is further characterized as being ethanol.

9. The dip coating formulation of claim 8 wherein the ethanol is anhydrous ethanol.

10. The dip coating formulation of claim 1 wherein the formulation comprises about 7 wt % terpineol.

11. The dip coating formulation of claim 2 wherein the formulation comprises about 7 wt % alpha terpineol.

12. The dip coating formulation of claim 1 wherein the formulation comprises about 7 wt % butoxyethyl acetate.

13. The dip coating formulation of claim 3 wherein the formulation comprises about 0.4 wt % acryloid.

14. The dip coating formulation of claim 3 wherein the formulation comprises 0.37 wt % acryloid.

15. The dip coating formulation of claim 4 wherein the formulation comprises about 0.4 wt % B-67 acryloid.

16. The dip coating formulation of claim 4 wherein the formulation comprises 0.37 wt % B-67 acryloid.

17. The dip coating formulation of claim 3 wherein the formulation comprises about 0.4 wt % ethylcellulose.

18. The dip coating formulation of claim 3 wherein the formulation comprises 0.37 wt % ethylcellulose.

19. The dip coating formulation of claim 5 wherein the formulation comprises about 0.4 wt % T-200 ethylcellulose.

20. The dip coating formulation of claim 5 wherein the formulation comprises 0.37 wt % T-200 ethylcellulose.

21. The dip coating formulation of claim 6 wherein the formulation comprises about 1.2 wt % Emcol.

22. The dip coating formulation of claim 6 wherein the formulation comprises 1.17 wt % Emcol.

23. The dip coating formulation of claim 7 wherein the formulation comprises about 1.2 wt % Emcol CC-42.

24. The dip coating formulation of claim 7 wherein the formulation comprises 1.17 wt % Emcol CC-42.

25. The dip coating formulation of claim 1 wherein the formulation comprises about 65 wt % YBa₂Cu₃O₆₊ₓ.

26. The dip coating formulation of claim 1 wherein the formulation comprises 65.15 wt % YBa₂Cu₃O₆₊ₓ.

27. The dip coating formulation of claim 1 wherein the formulation comprises about 19 wt % ethanol.

28. The dip coating formulation of claim 8 wherein the formulation comprises about 18.94 wt % ethanol.

29. The dip coating formulation of claim 9 wherein the formulation comprises about 19 wt % anhydrous ethanol.

30. The dip coating formulation of claim 9 wherein the formulation comprises about 18.94 wt % anhydrous ethanol.

31. The dip coating formulation of claim 1 wherein the formulation has a viscosity ranging from about 60 cPs to about 125 cPs.

32. A method for applying a superconducting coating onto a substrate by dip coating, the method comprising:
providing a dip coating formulation comprising
from about 6 to about 8 wt % terpineol,
from about 6 to about 8 wt % butoxyethyl acetate,
from about 0.4 to about 1.0 wt % of a binder,
from about 0.5 to about 2 wt % of a dispersant,
from about 60 to about 70 wt % YBa₂CU₃O₆₊ₓ, and
from about 18 to about 20 wt % of an alcohol;
dipping the substrate in the dip coating formulation;
removing the substrate from the dip coating formulation;
drying the substrate;
baking the substrate;
sintering the substrate.

33. The method of claim 32 wherein drying step further comprises rotating the substrate while the substrate is drying.

34. The method of claim 33 wherein the rotating and drying step is further characterized as rotating the substrate at about 300 rpm.

35. The method of claim 33 wherein the rotating and drying step is further characterized as drying the substrate at a temperature of about 90° C.

36. The method of claim 32 wherein the baking step is carried out at a temperature of about 80° C. and for a time period of about 20 minutes.

37. The method of claim 32 wherein the formulation has a viscosity ranging from about 60 to about 125 cPs.

38. The method of claim 32 wherein the terpineol is further characterized as being alpha terpineol.

39. The method of claim 37 wherein the binder comprises about equal amounts of acryloid and ethylcellulose.

40. The method of claim 30 wherein the binder is further characterized as comprising T-200 ethylcellulose and B-67 acryloid.

41. The method of claim 32 wherein the dispersant is Emcol.

42. The method of claim 41 wherein the Emcol is further characterized as being Emcol CC-42.

43. The method of claim 32 wherein the alcohol is further characterized as being anhydrous ethanol.

44. A method of preparing a formulation for dip coating a superconducting coating onto a substrate, the method comprising:
providing at least two solvents comprising terpineol and butoxyethyl acetate;
dissolving binder and dispersant in the solvents to form a vehicle;
milling YBa₂Cu₃O₆₊ₓ powder and the vehicle to produce an ink;
thinning the ink with ethanol to a viscosity ranging from about 60 cPs to about 125 cPs to produce the formulation.

45. The method of claim 44 wherein the formulation comprises
from about 6 to about 8 wt % terpineol,
from about 6 to about 8 wt % butoxyethyl acetate,
from about 0.4 to about 1.0 wt % of a binder,
from about 0.5 to about 2 wt % of a dispersant,
from about 60 to about 70 wt % YBa₂CU₃O₆₊ₓ, and
from about 18 to about 20 wt % of an alcohol.

46. The method of claim 45 wherein the terpineol is further characterized as being alpha terpineol.

47. The method of claim 45 wherein the binder comprises acryloid and ethylcellulose.

48. The method of claim 47 wherein acryloid is further characterized as B-67 acryloid and the ethylcellulose is further characterized as being T-200 ethylcellulose.

49. The method of claim 45 wherein the dispersant is Emcol.

50. The method of claim 49 wherein the Emcol is further characterized as being Emcol CC-42.

51. The method of claim 45 wherein the alcohol is further characterized as being anhydrous ethanol.
